(19) United States
(12) Patent Application Publication
(10) Pub. No.: US 2007/0245149 A1
(43) Pub. Date: Oct. 18, 2007

(54) Method for obtaining meaningless password by inputting meaningful linguistic sentence

(75) Inventor: Tai-Hung Lin, Taipei (TW)

Correspondence Address: HDSL, 4331 STEVENS BATTLE LANE, FAIRFAX, VA, 22033, US

(73) Assignee: Ares International Corporation

(21) Appl. No.: 11/377,420

(22) Filed: Apr. 17, 2006

(51) Int. Cl. H04L 9/00

(52) U.S. Cl. 713/184

(57) ABSTRACT

In a method for inputting a long sentence into a conversion function to generate an account password, the long sentence is used as an input seed, and the seed is inputted into a pseudorandom function to generate a password; wherein the sentence is selected, obtained, remembered easily, and the sentence is modified as an input seed, and a one-way hash function is used as a basic pseudorandom function such as a poem: “Mountains cover the white sun, And oceans drain the golden river; But you widen your view three hundred miles, By going up one flight of stairs.” for a function seed input, and users can make different setting such as changing “golden river” into “Yangtze River” or adding a date of change or adding a server name to improve the level of difficulty of the function seed.

### BACKGROUND OF THE INVENTION

1. Field of the Invention

The present invention relates to a method for improving the security of a computer system, and more particularly to a method for preventing intruders or imposters to obtain a user account and a password.

2. Description of Prior Art

Any server needs to expose its service communication port on the Internet, and the exposed communication port is a target for malicious attacks, and the attack may result vicious consequences such as unauthorized accesses to user information, changes to a website or a webpage, and system crashes of a server.

Therefore, adopting a security measure to prevent malicious attacks becomes one of the major factors that should be taken into consideration for every network system. In the past decades, the use of passwords is a basic architecture for the authentication of information security. In general, a principal (such as a user) needs to enter a name and a password into a system for the user's authentication in order to obtain the access right of the system resources. The combination of a set of name and password is assigned to a user's account, so that the system can open certain rights for the account.

However, any authentication system that only uses a user name and a password to open the rights for users is a would-be intruder's attacking target, and intruders may use different methods to crack the account of a computer server. Generally, a user name can be determined or obtained by an unauthorized person easily. For example, an email address is a common user name of an account, and its password can be cracked by three main methods: guessing a simple password, a dictionary attack, and a brute force attack which are described as follows:

To make it easy to remember a password, many people use their birthday or the family's birthday, telephone number, room number, simple number, or identity number as the password, and some people even use the same password for all systems, or the factory default user account and password. Some people may disclose their password to others readily or hide the password under a mouse pad or stick the password next to a monitor, and some people use the word “password” as their password, or even do not set any password at all. For all of the above cases, intruders can guess or crack the password of a system easily.

Further, some people use an alphanumeric combination or permutation, or the name of their boyfriend, girlfriend, son, or daughter as the password. If the aforementioned attack fails, intruders may try the dictionary attack that uses a program to try every possibility of a single word in a dictionary. The dictionary attack can use repeated logins or collect an encrypted password and try to match a single word in the dictionary with the encrypted password. The malicious intruders usually use an English dictionary or a dictionary of another language as a basis for cracking the password. Further, some people also use a database of different dictionaries such as a database of names and commonly used passwords.

The brute force attack is similar to the dictionary attack, and intruders use a dedicated computer and program to try all possible combinations of characters by a brute force. Nowadays, the operating speed of computers becomes faster and faster, and thus a password containing 4 lowercase alphabets can be cracked in a few minutes. For longer passwords containing digits, punctuations, and uppercase and lowercase alphabets, there are tens of trillions of possible combinations and permutations and the longer passwords can be cracked within a month. At present, the password cracking software for intruding corporate networks claims that such software can complete eight million trials in a second.

Therefore, a main cause for the intrusions made by an imposter resides on the insufficient protection of the password, and thus an imposter can guess the password easily. Although a one time password (OTP) is developed now to improve the identity authentication and replace the traditional password authentication, yet the OTP method as well as the systems using other methods for substituting or assisting password such as soft tokens, smartcards, or certificate as a base incur a high cost and such OTP method is not available to all.

In the meantime, different systems have different requirements for their security. For simplicity, most people use the same password for all of their accounts such as email address and workstation account. If a computer system with a lower security level is attached, the user account will be disclosed and the chance for such account to allow intruders to control other systems will be increased greatly.

Till now, if both security and practicability are taken into consideration, the best way for protecting the security of a system is to prohibit users using an old password (by means of compulsory password history), restrict the time between two times of changing passwords (by means of maximum password life and minimum password life), and the minimum password length, and require users to mix uppercase and lowercase alphabets, numerals and special characters (wherein the password must satisfy the requirements of the complexity).

Theoretically, users should design 18˜23 meaningless words to avoid the dictionary attack and change the words once every 2˜3 months, when the present password cracking technology is taken into consideration. In the meantime, a separate password is used for different working systems preferably.

However, ordinary people may have difficulties to remember the meaningless scrambled characters or may forget the password. Even if they can remember the password, users have to change the password once every two to three months. If the account of each system is different, users may be unable to distinguish the passwords used for different accounts, and thus causing problems in the use of the systems. What is worse, it may lock the account, and users have to go through a complicated procedure to reapply for the user account and password when they forget the password.

### SUMMARY OF THE INVENTION

In view of the foregoing shortcomings of the prior art, the inventor of the present invention based on years of experience in the related industry to conduct experiments and modifications, and finally designed a method for obtaining meaningless password by inputting meaningful linguistic sentence to overcome the shortcomings of the prior art.

The present invention is to overcome the shortcomings of the prior art by providing a method to assist users to establish a group of hard-to-forget and sufficiently long scrambled code as the password, so as to prevent intruders to access the account information through a brute force attack or access the system resources illegally. To prevent the system attack with an increasingly fast computation, the safest password should have 18˜23 characters and these characters should be changed once every 2 to 3 months. What is more, users should set different passwords for different servers. However, people have difficulties to remember a scrambled code with 18˜23 characters. In the meantime, it is very easy to loss a password or mix up with other passwords if too many groups of passwords are set, and thus the passwords cause confusions in their use. Thus, the present invention adopts a conversion function to input an easily remembered sentence to obtain a password, and users can obtain the scrambled code by an easily remembered sentence. Since a meaningful sentence is easier than the scrambled code for users to remember, therefore users may not forget or loss the passwords established by themselves.

To overcome the problems of forgetting the passwords, the present invention uses an easily available sentence as a base, and then converts the sentence into a set of irreversible password by a conversion function. Therefore, users have to remember the origin of the sentence or the textual content of the sentence. Compared with the meaningless scrambled code, the meaningful sentence is much easy to remember. Meanwhile, users can easily remember the sentence without writing it down at a specific place, and thus the password generated by the method according to the present invention is highly portable and convertible, and users just need to save the conversion function into a portable electronic equipment, so as to obtain a long effective password by entering the sentence.

Another, the present invention is to prevent intruders to know about the user's habit which may increase the possibility of cracking the password of the system again. If a system is attacked and the account data is disclosed, or even the system requests users to change their password, the intruders can refer to the disclosed account data to obtain the habit that users set their passwords. If the intruder intrudes the system again, the account and password will be guessed easily, and thus greatly lowering the system security.

In summation of the description above, the present invention is a method that uses an easily available sentence as a base and enters the long sentence into a conversion function to generate an account password, wherein the present invention uses a pseudorandom function as a password generating function. Users enter a sentence into the conversion function to generate a string of scrambled codes to be used as an account password by users. The sentence is a hard-to-forget, easy-to-remember sentence that can be selected and obtained easily, so that a user can systematically remember or easily inquire the password, and thus such arrangement can avoid users from forgetting the password. In the meantime, the password generated by the conversion function is arranged in scrambled codes, and thus the system will not be intruded by a malicious imposter easily, such that the personal data will not be disclosed, or the computer system will no longer have the risk of being damaged. In the meantime, the present invention uses a pseudorandom function as a conversion function. Due to the characteristics of the pseudorandom function, a seed is inputted similarly to obtain the same output of the seed, so that users can remember the cited sentence. If it is necessary to log in a system, the sentence will be inputted into the pseudorandom function to obtain the password.

In addition, the invention preferably adopts a one-way hash function as the base for the random number generating function. The one-way hash function is a non-decompressible (one-way) method. In other words, an input cannot be obtained from the known output, or any two inputs for outputting the same result cannot be obtained. On the other hand, the pseudorandom function can generate a long series of unpredictable random bits. Therefore, the method of generating a password according to the present invention has a high security, and even if the password is known, the original seed sentence will not be obtained, so as to effectively protect the habit adopted by users, and the password will be more difficult to crack again after the password is changed.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a schematic view of applying a hash function according to the present invention;

FIG. 2 is a schematic view of a scope of applicability of the present invention;

FIG. 3 is a schematic view of a preferred embodiment of the present invention;

FIG. 4 is a schematic view of another preferred embodiment of the present invention; and

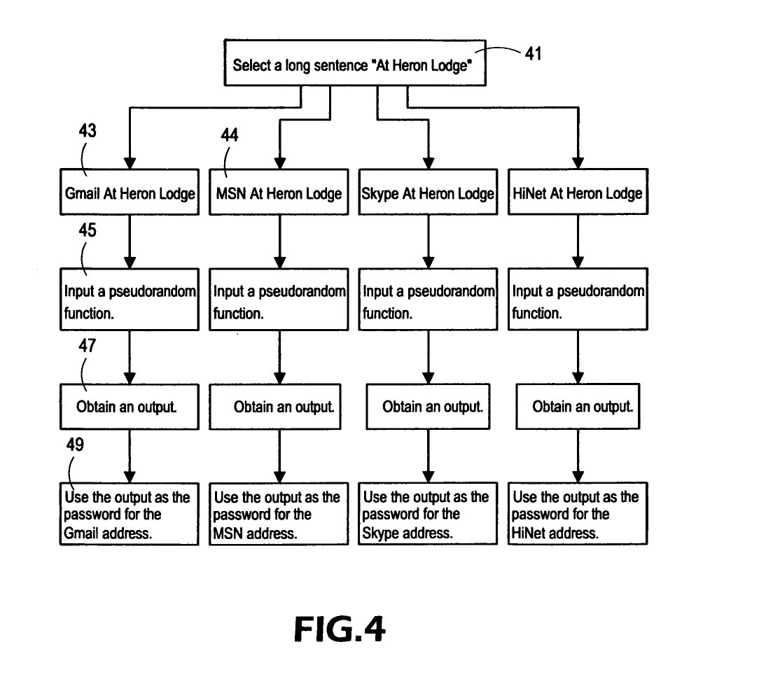

FIG. 5 is a flow chart of the present invention.

### DETAILED DESCRIPTION OF THE INVENTION

The technical characteristics, features and advantages of the present invention will become apparent in the following detailed description of the preferred embodiments with reference to the accompanying drawings.

The present invention relates to a method that uses an easily accessible, easy-to-remember, or easy-to-save sentence as a base to generate a user account password and a conversion function. The sentence acts as an input to the conversion function to produce a string as the characters of the password and facilitate users to use the account password. Therefore, the present invention assists users to use the sentence to generate meaningless scrambled codes. Since the sentence can be selected and obtained easily, hard-to-forget, or easy-to-save in personal memory, therefore the password can be remembered systematically or inquired easily, so as to save the trouble caused by users' forgetting the password. In the meantime, the password generated by the conversion function is arranged in random, and thus the system will not be intruded by malicious imposters, which will cause a disclosure of the data or a damage of the computer system.

For example, a user needs to select a familiar sentence such as the first ten sentences of the lyrics of a popular song as an input seed of the conversion function. The sentence is converted by the conversion function and inputted into a computer system, and the random characters are received by the password and provided for users to duplicate into a password filed for logging in the system. Since the length of the password received by each system varies, users will select the length according to system requirements for the account password of the system. If the system does not have any requirement for the length of a password, then the random number generated by the function can be used as the account password. The conversion function is a pseudorandom function, and the output result is converted into a string of random numbers permissible by the password.

To let users generate the same password with the same sentence, the present invention uses a pseudorandom function as the conversion function. Due to the characteristics of the pseudorandom function, the same seed is inputted to output the same random number, and thus users can remember the cited sentence. If a user wants to log in a system, the user simply enters the sentence into the pseudorandom function to obtain the password.

It is preferably to use an easily accessible sentence as the remembered information, and thus a popular or best seller book such as a certain chapter or section of the Bible or a chapter of the Analects of Confucius is selected as the seed. Since the Bible and the Analects of Confucius are very popular and both can be checked easily in any bookstore, therefore users do not have to remember the sentence. If the users want to input the sentence, the users can look up the sentence in any bookstore or bookshelf. Further, a certain keyword of the seed sentence can be inputted into a search engine of the Internet for inquiry.

Users simply need to remember the cited book, chapter, section, and number, so that users no longer need to write down the nonsystematic scrambled code or copy the password next to a computer or carry the password in a wallet. In other words, users just need to remember the origin of the sentence instead of a meaningless scrambled code consisting of a series of alphanumeric characters and symbols.

Although these sentences can be obtained easily, the selected paragraph and sentence depend on users' decision. Therefore, even if malicious intruders know that the user's cited sentence comes from the Bible, intruders still do not know which paragraph or section of the Bible is selected, since the Bible has huge contents, and thus making the cracking of password uneasy. Further, each book may have different versions, such as the Bible has Union version and Catholic version, etc. In the meantime, different languages such as English or Chinese can be selected for the input, so that the versions and languages provide more possible combinations and permutations, and thus improving the level of difficulty for cracking a password.

In addition, users also can select to remember the sentence. To make it easy to remember the sentence, it is preferably to use the sentence that is hard to forget or the users have previously recited such sentence. The sentence is part of the recited poem or the lyrics of a popular song, etc. Since it is easy to remember and hard to forget the song or verse, therefore users can extract a portion or the whole of a certain paragraph of the song or a verse as the input seed.

Today, the speed of the processors becomes faster and faster, and the algorithms used by intruders are getting better and better. To provide the safest protection for user accounts, the longer the account password, the more difficult is the cracking the password theoretically. Therefore, the longer the cited sentence, the harder is the generation of password, and the more difficult is the cracking of the password. The present invention relates to a method for generating a long sentence to produce a powerful password. On the other hand, users no longer need to remember those difficult scrambled codes.

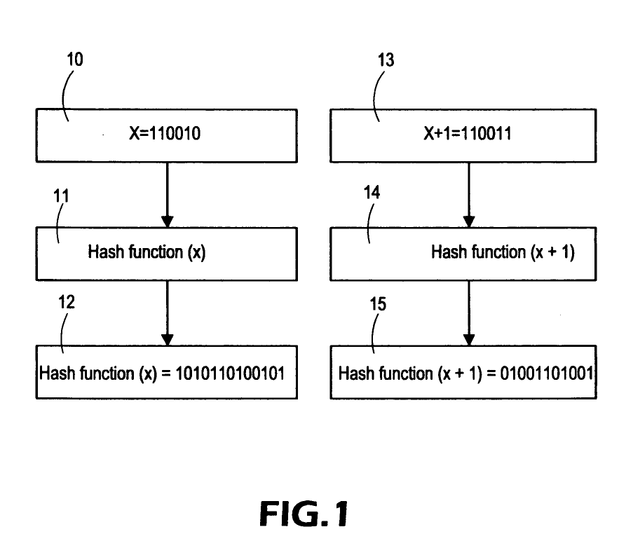

The user's inputted sentence is prevented from being obtained by other malicious intruders and the user's habit of selecting the sentence is prevented from being exposed before the intruder, so as to lower the possibility of the cracking of a password by intruders. To achieve these objectives, the present invention adopts a one-way hash function as a base for the random number generating function. The one-way hash function is a non-decompressible (one-way) method. In other words, the input cannot be obtained from the known output, or any two inputs having the same output cannot be found. Referring to Block 10 as shown in FIG. 1, if x=110010 is inputted, the output of a hash function will be 1010110100101 as shown in Block 12. On the other hand, if x+1=110011 is inputted into the hash function, the obtained output Block 15 is 01001101001. Therefore, the outputs between the hash function (x) and the hash function (x+1) are not related. On the other hand, the pseudorandom function can produce a long series of unpredictable random bits with a long cycle. Therefore, the method of generating password according to the present invention has a high security. Even if the password is known, the original seed sentence cannot be obtained, and thus the invention can effectively protect the user's selecting habit and make the cracking of a password more difficult after the password is changed again.

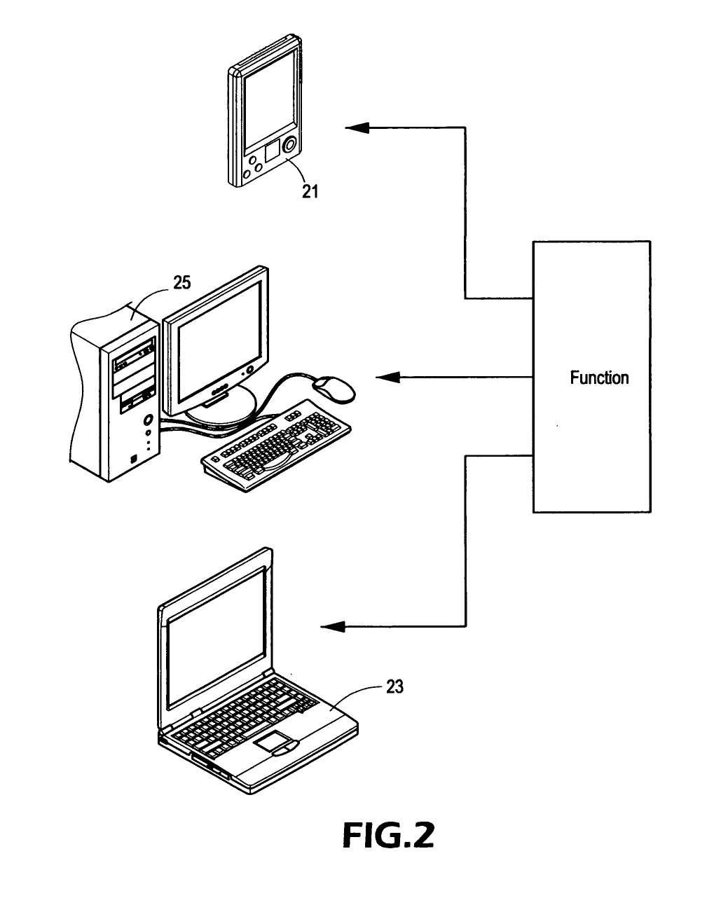

Referring to FIG. 2, the method of the invention provides a highly portable password generator. For example, the original code of the conversion function is downloaded publicly, users can copy the function into a personal computer 25 or a portable electronic computing device such as a personal digital assistant 21 (PDA) or a notebook computer 23. No matter where the password is needed, users can input the sentence anytime to generate the long password. Further, users also can generate the password by downloading the function from a place with a computer and the Internet such as an Internet café. Therefore, the password is available handy and the present invention certainly improves the convenience of use.

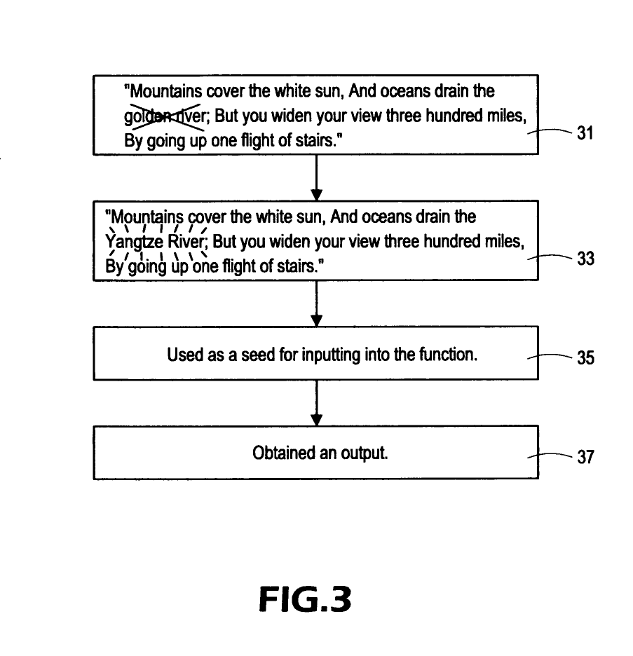

Referring to FIG. 3, a small section of the input sentence is modified to avoid the password from being repeated too easily. For example, the poem “At Heron Lodge” by Wang, Zhi-huan is adopted as the function seed, and its original text is shown in Block 31:

“Mountains cover the white sun, And oceans drain the golden river. But you widen your view three hundred miles, By going up one flight of stairs.”

To improve the security of the password, the original text can be modified reasonably according to actual situations, such as modifying “golden river” to “Yangtze River” and the input seed will become the one as shown in Block 33:

“Mountains cover the white sun, And oceans drain the Yangtze River. But you widen your view three hundred miles, By going up one flight of stairs.”

Further, a same word can be inserted into the intervals of the sentence as follows:

“Mountains cover the white sun, Ah, And oceans drain the golden river, Ah. But you widen your view three hundred miles, Ah, By going up one flight of stairs, Ah.”

Alternatively, the poem can be inputted in a reverse order, and all of the arrangements are the method of slightly modifying the sentence. It is worth to point out that such modified section is set by the user, and other people cannot obtain such section easily. Finally, the modified sentence becomes the seed of the pseudorandom function as shown in the Blocks 35˜37.

To further enhance the password security, the password should be updated regularly, and different accounts should have different passwords. Therefore, a password generating condition is added, which can be accomplished by modifying several long sentences. For example, users can append the code or name of the desired login system to the long sentence to prevent users from using the same password for all accounts.

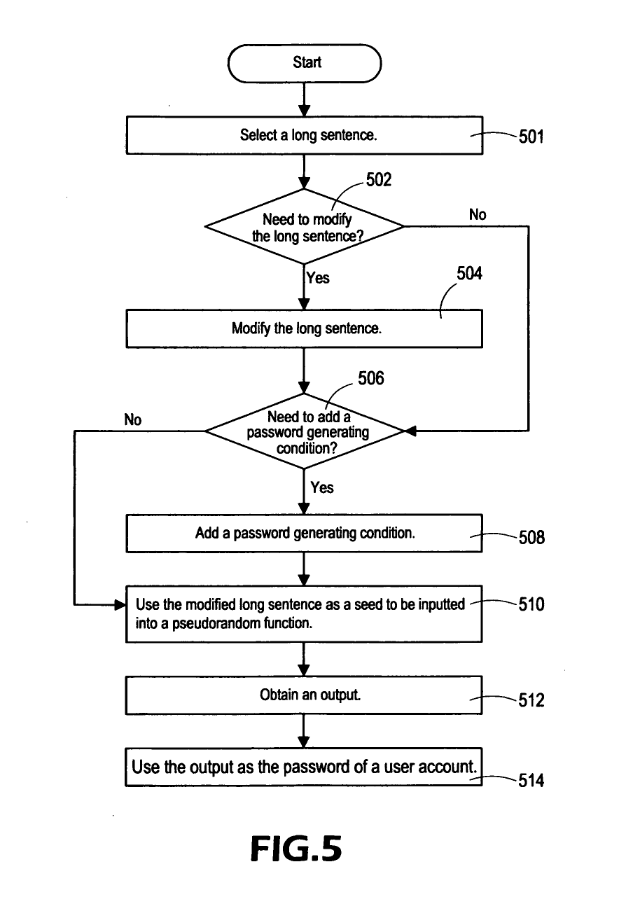

For example, a user has a Gmail address, a Skype account, a MSN account, and a Hinet email address as shown in FIG. 5, and the long input sentence is selected from the poem “At Heron Lodge” as shown in the Block 41. To set different passwords for different accounts, the user uses the “long sentence” plus the “server name” as the input seed. In other words, the input seed of the Gmail address is “Gmail At Heron Lodge” as shown in the blocks 43, 44; the input seed of the Skype account is “Skype At Heron Lodge”, and so on. It is worth pointing out that the user can selectively place the account in front of, in the middle of, or behind the long sentence. Such sentence is then used as a seed to be inputted into the pseudorandom function, and the obtained output is used as a password for each account as shown in Blocks 45 to 49.

Since it is necessary to change the system password once in a while, therefore users can consider appending an expiration date or a setup date of the password to the long sentence, so as to meet the requirements of changing the password regularly. Similarly, the example as shown in FIG. 5 is used for illustration. If the password of the Gmail address is set on Jan. 1, 2005 and the date for setting the password of the Gmail address for the next time is Apr. 1, 2005, then the seed of the input function is “At Heron Lodge Gmail2005/01/01˜2005/03/31”.

Further, the password can be generated by selecting different encoders. Using the foregoing “At Heron Lodge” for example, we can add punctuations to the poem, so that the seed becomes:

“Mountains cover the white sun, And oceans drain the golden river; But you widen your view three hundred miles, By going up one flight of stairs.”

As to the non-English speaking countries, the invention includes a selection of encoder. Using Chinese for example, we have the BigS code and the 4-bit universal character set (UCS4) etc, and Chinese is also divided into simplified Chinese code and Traditional Chinese code. We also can use phonetic notation or phonetic transcription for the code to avoid inputting a wrong or misspelled character when inputting Chinese.

Referring to FIG. 5 for the flow chart of the present invention, a user requests to login a system and receives a login message from a server and then the user selects a long sentence first (as shown in Step 501); the user selects whether or not to modify the long sentence, and the user decides not to modify the long sentence but maintains the original text of the long sentence (as shown in Steps 502˜504); the user sets different passwords for different accounts to improve the security (as shown in Step 506), but such step is not absolutely necessary, and the user may set the same password for all accounts; and finally the user inputs the obtained long sentence into the pseudorandom function to generate an account password from the input and copies and inputs the password into the server (as shown in Steps 510 to 514).

The present invention are illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A method for assisting users to generate a powerfil password, comprising:
selecting a series of words from a known sentence;
using the words as a seed to be inputted into a random number generator;
selecting an output of the random number generator to form a password which is used appropriately for logging in a computer or a server system.

2. The method of claim 1, wherein the output of the random number generator includes an alphabet.

3. The method of claim 1, wherein the output of the random number generator includes a number.

4. The method of claim 1, wherein the output of the random number generator includes an alphanumeric combination.

5. The method of claim 1, wherein the random number generator includes a pseudorandom function.

6. The method of claim 5, wherein the pseudorandom function uses a hash function as a base.

7. The method of claim 1, wherein the words are changed to serve as a seed which is inputted into the random number generator.

8. The method of claim 1, wherein the seed further comprises a code for logging in the system.

9. The method of claim 1, wherein the seed further comprises an appropriate date for setting the password.
